(19) United States
(12) Patent Application Publication
(10) Pub. No.: US 2015/0075655 A1
(43) Pub. Date: Mar. 19, 2015

(54) FLUIDS ECONOMIZER SYSTEM

(71) Applicants: Jose Luis Ricardo Otarola Olguin, Renca (CL); Juan Manuel Lopez Delgado, Renca (CL)

(72) Inventors: Jose Luis Ricardo Otarola Olguin, Renca (CL); Juan Manuel Lopez Delgado, Renca (CL)

(21) Appl. No.: 14/303,011

(22) Filed: Jun. 12, 2014

(30) Foreign Application Priority Data
Sep. 13, 2013 (CL) 2643-2013

(51) Int. Cl. G05D 7/06

(52) U.S. Cl. CPC G05D 7/0652; G05D 7/0647
USPC 137/601.14

(57) ABSTRACT

The present invention relates to the field of Hydraulic Engineering and, particularly, to a fluids economizer system, useful for saving water during distribution in industrial and residential facilities. The system is based on the utilization of devices for the cutoff of fluid flow and manual regulation of fluid flow, which are placed in an arrangement that allows four alternative and programmable states of pressure and rate of the fluid flow to be achieved for efficient supply in the facilities where the system is placed.

### FIELD OF THE INVENTION

The present invention relates to the field of Hydraulic Engineering and, particularly, to a fluids economizer system, useful for saving water during distribution in industrial and residential facilities.

### BACKGROUND OF THE INVENTION

The severe shortage of drinking water generates the need to use different technical mechanisms for resolving the environmental concerns, in order to generate massive savings in constructions with a high intake of fluid.

The shortfall of the precious liquid has focused many manufacturers to offer items and accessories in more efficient water use, showing the renovation of the infrastructure with innovations that improve quality of life and, at the same time, significantly reduce the consumption of water traditionally used.

These devices are usually related to water saving in restrooms, urinals, showers, washbasins and sinks faucets, Where almost 70% of the expenditure of this fluid is generated.

Nevertheless, the utilization of water-saving systems for communal use, located “in situ” in large facilities such as buildings, where the use of this fluid is required, is an aspect usually shortly addressed in the state of the art.

The state of the art discloses diverse systems, implemented to save water in constructions where they are placed.

Such is the case of the utility model, application number CN202248088, which describes an intelligent system for water supply, comprising a pump for pressure stabilization, as well as a solenoid valve and a proportional valve, which are sequentially connected with the pressure stabilization pump through a pipe. A pressure sensor and a flow sensor are arranged between the pressure stabilization pump and the solenoid valve. The intelligent system for water supply further comprises a main control unit, which is communicatively connected to the pressure sensor, the flow sensor, the solenoid valve and the proportional valve, respectively. The intelligent system for water supply can ensure a stable source of water for water supply, intelligently water supply, according to the scale of the equipment that use and save water, while ensuring the technological needs.

Furthermore, the utility model application number CN201195857, describes a water supply device of campus timing, which belongs to the control equipment using electrical appliances, in particular, to the control equipment of water supply. The water supply device, which controls the timing of the campus, comprises a main water supply pipe, a shut-off valve and a piping system of water use. The utility model is characterized by a solenoid valve, which is controlled by a programmable timer, is mounted behind the shut-off valve of the main water supply pipe. The timer is set in order to open the solenoid valve to ensure water supply at the school where is placed, when classes begin, and close the solenoid valve to stop water supply, when school period ends, through the use of a programmable timer, according to the time of the school period. The flow reaches the passage of water into the pipes when students make use of the water pipe and main water supply pipe is closed by the solenoid valve, when school finishes. Even if the water faucets are not closed or not fully closed, the timer can stop the continuity of the flow, so the water supplying device saves time and labor, which allows saving a considerable amount of water.

Nevertheless, previous systems cannot achieve different states of fluids pressure, as they only allow the supply being the maximum or minimum possible.

The Chilean Patent No. 49431, on the other hand, describes a drinking water economizer system, which is installed in the main matrix of the water network in a building that enables the generation of three states of pressure, programmable according to schedules of water demand, through a previous study of influx of personnel into the facilities. Its aim is to develop savings and water efficiency in water networks or devices connected to the intervening matrix. The water economizer is comprised of water equipment, which comprises a pipe section or entry of water equipment, which is flow and pressure supplied by a water meter. The pipe is connected to a T, which is connected to two lines of pipes, and through American elbows and unions supplies flow and pressure to a high pressure solenoid valve and to another low pressure solenoid valve, to supply flow and pressure to the T, which is connected to a pipe called output of the water equipment, interacting electrically with a programmable logic controller, which by its two electrical outlets regulates the opening and closing of the solenoid valves, according to pre-assigned and planned schedules.

This patent, although allows the achievement of more than two states of water pressure, high pressure, low pressure and flow suspension, still has the disadvantage that the arrangement of the elements included in the system, only allows to program and implement three states of fluid pressure. That is to say, a state of high pressure, which is considered in the range between about 70% and 100% of possible total pressure of the fluid, a state of low pressure, which is considered in the range between approximately 10% and 69% of the possible total pressure of the fluid, and the state of suspension of the fluid, where the pressure and flow is 0% accordingly.

The present invention application constitutes a different provision of flow control devices as disclosed in the Chilean Patent No. 49431, and its novelty lies in the arrangement of the elements in the fluids economizer system for programming and obtaining four alternative states of supply of the fluid flow, which are: a maximum supply state of the fluid, which is considered in the range between approximately 80% and 100% of the possible total pressure of the fluid, a medium supply state of the fluid, which is considered in the range between approximately 10% and 79% of the possible total pressure of the fluid, a minimum supply state of the fluid, which is considered in the range between approximately 1% and 9% of the possible total pressure of the fluid and the total suspension, where the pressure is 0%. This is achieved because the fluid control is executed through valves and stopcocks alternately.

The present patent application provides greater flow control of the fluid to the construction and, thus, generates greater savings of the fluid when conceiving a pressure state of the supply of the minimum flow (1% to 9%), range of supply that is not covered in the Chilean Patent No. 49431.

The implementation of this fourth state, minimum supply state of the fluid flow, is particularly necessary and useful for buildings that for reasons of rules or security measures, cannot suspend the supply of the fluid, and the user needs to generate an evening minimum pressure different than the intermediate pressure programmed for diurnal periods. The present application does technically meet the requirement, through its minimum supply state (1%-9%), by providing a pressure and flow well below the maximum supply states (80%-100%) and medium supply states (10% 79%) of the fluid flow. On the other hand, the Chilean Patent 49431 is limited by its 3 pressure states, offering to the user the suspension in evening periods or the same low pressure (10%-69%) programmed for daylight hours, generating less control and, therefore, less water efficiency to the construction.

### SUMMARY OF THE INVENTION

The present invention relates to a fluids economizer system, whose main purpose is to rationally manage the flow of a fluid in a network where it is installed, without affecting the operability and demand of said fluid.

### BRIEF DESCRIPTION OF THE DRAWINGS

FIG. 1 is a schematic representation of the fluids economizer system of the present invention.

FIG. 2 is a schematic representation of a three pipe system used in an embodiment of the present invention.

### DETAILED DESCRIPTION OF THE ILLUSTRATIVE EMBODIMENT

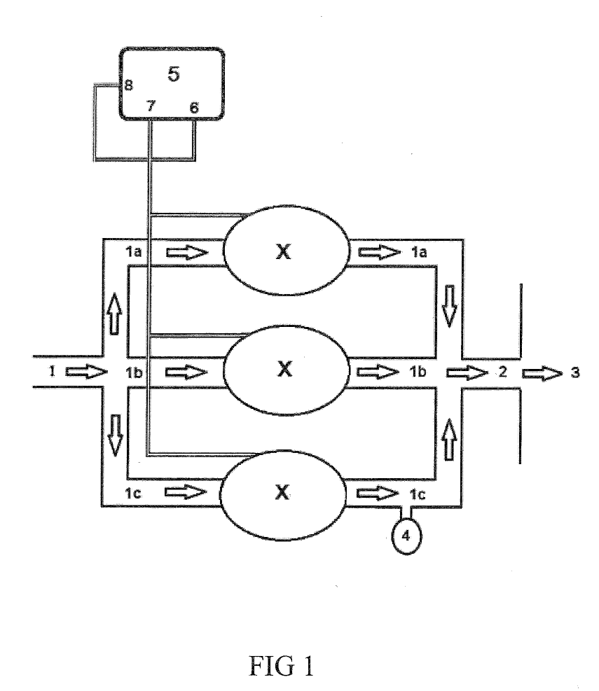

FIG. 1 shows a schema that defines the components of the fluids economizer system, object of the invention of the present application, and the arrangement thereof.

The system comprises a fluid inlet (1) which is branched to a plurality of pipes (1a, 1b, and 1c) which are arranged in parallel with respect to each other, where each pipe includes one or more devices for regulation of the fluid flow (X) connected in series, which are selected from among devices for suspension of the fluid flow and devices for manual regulation of the fluid flow or a combination of both, a plurality of pipes (1a, 1b and 1c) next to the devices for regulation of the fluid flow that converge in a single fluid outlet of the system (2), which in turn communicates with the fluid inlet to the edification or facility where the system is placed (3) and an electronic control unit (5) connected to devices for suspension of the fluid flow, said system which is characterized by including a barometer (4) placed next to any of the devices for the regulation of the fluid flow (X), located in any of the pipes (1a, 1b and 1c) and before its confluence in the outlet of the system (2).

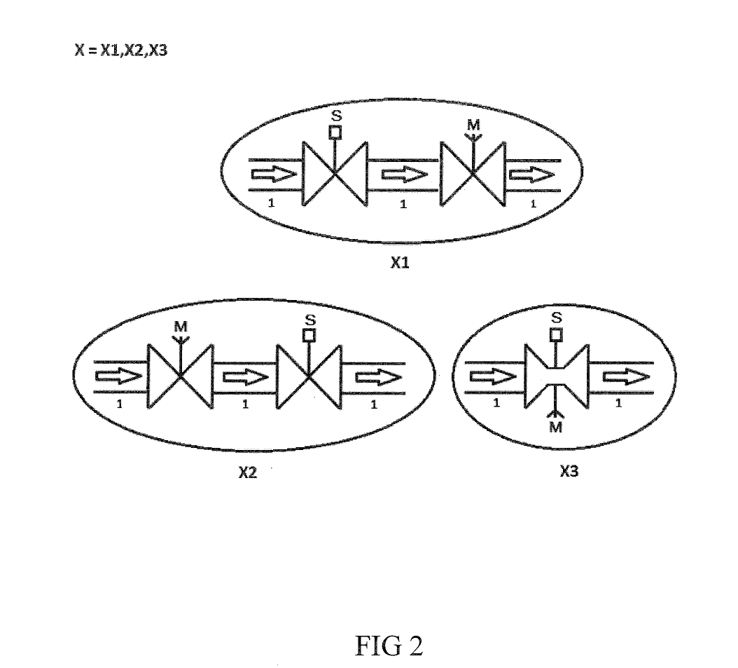

In another preferred embodiment, the devices for suspension of the fluid flow are solenoid valves (S) (FIG. 2).

In a preferred embodiment of the invention, the devices for the manual regulation of the fluid flow are valves (M) (FIG. 2).

In another preferred embodiment, the combination of both devices is a valve comprising both a stopcock (M) and a solenoid (S) (FIG. 2).

In FIG. 2 the different variants (X1, X2 and X3) that may exist in the arrangement of the devices for the regulation of the fluid flow (X) in a pipe (1) are observed, all of which control the fluid flow similarly.

Since these variants can be replicated, exchanged or combined in each of the pipes (1a, 1b and 1c), for its graphically representation, variants are illustrated in any pipe, which has been generically called (1), in which, for example, an arrangement (X1) represents the variant in which firstly a device for the suspension of the fluid flow, preferably a solenoid valve (S) is provided; and next to it, in series, one device for the manual regulation of the fluid flow, preferably a stopcock (M), or alternatively an arrangement (X2) in which firstly a device for the manual regulation of the fluid flow, preferably a stopcock (M) is provided; and next to it, in series, a device for the suspension of the fluid flow, preferably a solenoid valve (S), and an arrangement (X3) in which a combination of both devices for suspension or solenoid valve (S) and for manual regulation of the fluid flow or stopcock (M) is placed.

The above arrangements may be either repeated, exchanged or combined in the remaining pipes; thus achieving all the possible alternatives of arrangements of the different devices for the regulation of the fluid flow in the system object of the present invention.

In a preferred embodiment of the invention object of the application that is shown in FIG. 2, in which the arrangement (X1) in the three pipes (1a, 1b and 1c) is followed, respectively, i.e. in the pipe (1a) the solenoid valve (S) is firstly disposed and next to it, in series, a stopcock (M) is disposed; in pipe (1b) a solenoid valve (S) is also firstly disposed and next to it, in series, a stopcock (M) and in the pipe (1c) a solenoid valve (S) is disposed and next to it, in series, a stopcock (M) is disposed, the fluids economizer system operates as follows:

Is supplied with fluid through the pipes (1a, 1b and 1c) the inlet to a first device for the regulation of the fluid flow in the different pipes, in this case, the input to the solenoid valve (S) of (1a), the inlet to the solenoid valve (S of) (1b) and the inlet to the device (S) of (1c). The fluid outlet of the solenoid valve (S) of the pipe (1a), allows supplying with fluid the stopcock (M) of (1a). The fluid outlet of the solenoid valve (S) of the pipe (1b), similarly allows supplying with fluid the stopcock (M) of (1b). The fluid outlet of the solenoid valve (S) of the pipe (1c), similarly allows supplying the stopcock (M) of (1c) with fluid. The fluid outputs of the stopcocks (M) from the pipes (1a, 1b and 1c) respectively, as the same as the barometer (4) are interconnected by sections of the corresponding pipes, which, when converge, meet the objective of supplying fluid to the fluid outlet of the pipe (2), which communicates with the fluid inlet to the construction or facility where the system is placed (3).

In a preferred embodiment of the present invention, the electronic control unit (5) is a Programmable Logic Controller (PLC), from which electrical conduits containing electrical conductors (6, 7 and 8) are derived, which electrify the solenoid valves (S) of the pipes (1a), (1b) and (1c). Said Programmable Logic Controller (PLC) is programmed with control times, which allows generating four states of fluid supply to a building, as explained below.

### EXAMPLES OF EMBODIMENT

The supply states of fluids obtained by using the economizer system are:

a) Maximum supply state of the fluid (which provides a fluid pressure and flow in the approximate range of 80% to 100% allowable total): It is a pre-established condition, programmed in the P.L.C, which only electrifies the output conductor (6) connected to the solenoid valve (S) of the pipe (1a), being de-energized the solenoid valves (S) arranged in the remaining pipes of the plurality of pipes (1b, 1c). This action generates only the opening of the solenoid valve (S) of the pipe (1a), whereas the solenoid valves (S) in the pipes (1b, 1c) are closed, allowing only the passage of fluid in the input pipe of the system (1) through the pipe (1a). This transfer of fluid generates the fluid supply to the stopcock (M) of the pipe (1a), regulated in an approximate range (80% to 100%), providing the maximum supply of the fluid to all sections of pipes, parts and pieces connected to the fluid outlet of the system (2) which communicates with the fluid inlet to the construction or facility where the system is placed (3).

b) Medium supply state of the fluid (which provides a fluid pressure and flow in the approximate range of 10% to 79% allowable total): It is a pre-established condition, programmed in the P.L.C, which only electrifies the output conductor (7) connected to the solenoid valve (S) of the pipe (1b), being de-energized the solenoid valves (S) arranged in the remaining pipes of the plurality of pipes (1a, 1c). This action generates only the opening of the solenoid valve (S) of the pipe (1b), whereas the solenoid valves (S) in the pipes (1a, 1c) are closed, allowing only the passage of fluid in the input pipe of the system (1) through the pipe (1b). This transfer of fluid generates the fluid supply to the stopcock (M) of the pipe (1b), regulated in an approximate range (10% to 79%), providing the medium supply of the fluid to all sections of pipes, parts and pieces connected to the fluid outlet of the system (2) which communicates with the fluid inlet to the construction or facility where the system is placed (3).

c) Minimum supply state of the fluid (which provides a fluid pressure and flow in the approximate range of 1% to 9% allowable total): It is a pre-established condition, programmed in the P.L.C, which only electrifies the output conductor (8) connected to the solenoid valve (S) of the pipe (1c), being de-energized the solenoid valves (S) arranged in the remaining pipes of the plurality of pipes (1a, 1b). This action generates only the opening of the solenoid valve (S) of the pipe (1c), whereas the solenoid valves (S) in the pipes (1a, 1b) are closed, allowing only the passage of fluid in the input pipe of the system (1) through the pipe (1c). This transfer of fluid generates the fluid supply to the stopcock (M) of the pipe (1c), regulated in an approximate range (1% to 9%), providing the minimum supply of the fluid to all sections of pipes, parts and pieces connected to the fluid outlet of the system (2) which communicates with the fluid inlet to the construction or facility where the system is placed (3).

d) Suspension state of the fluid (pressure and flow 0%): It is a pre-established condition programmed in the PLC, in which none of the plurality of outputs (6, 7, 8) is electrified, whereby the closure of all the solenoid valves (S) arranged in the plurality of pipes (1a, 1b and 1c) is generated. This action generates the fluid suspension to all section of pipes, parts and pieces connected to the fluid outlet of the system (2) which communicates with the fluid inlet to the construction or facility where the system is placed (3).

As can be seen, the present invention allows to regulate the pressure that is delivered to a given facility, as desired by the user of the system, resulting in the four previously mentioned supply states of the fluid. This will allow the economization of the fluids flow, in a fully programmed system in a given installation, managing the supply, according to the previous knowledge of the influx of personnel to facilities that require it, defining the appropriate schedules for each desired state, which can be programmed using a Programmable Logic Controller (PLC) and which can be accessed remotely, for example via Internet connection.

The fluid flow economizer system can be placed in any portion of the primary matrix of drinking water, preferably after the water meter, as explained above.

It is conceived as the main matrix, the pipe of any diameter and building material which provide fluid flow in a pipe network in a construction.

The diameter of the fluid economizer system will be dependent on the diameter of the main matrix of the facility where is to be installed.

Thus, the four described supply states, achieved according to the present patent application, can be properly programmed when the use and flow schedule of fixtures (toilets, sinks, showers, etc.) by the personnel at the constructions is known.

In another preferred embodiment of the invention application, the fluid economizer system is comprised of a Programmable Logic Controller or PLC (5) which can be fitted with a radio frequency receiver and a radio frequency transmitter (remote control), in a way that the radio frequency transmitter generates a binary aerial signal, which is controlled through control buttons located on the surface of the transmitter (remote control). This action is used when required to activate the maximum supply state of the fluid, at scheduled times of medium, minimum or suspended supply state of the fluid, respectively, creating a break in the preset pressure and flow schedules by a time scheduled in the PLC (5), enabling the maximum supply state of the fluid. After the time allotted to the radio frequency transmitter (remote control), PLC (5) takes the pre-established schedule. Once the time allotted to the radio frequency transmitter (remote control) ends, the PLC (5) returns the pre-established schedule.

The fluid economizer system can be optionally powered using a solar panel connected to a battery charger and connected to a battery that stores the energy produced by the solar panel, allowing the electric range. Furthermore, it can also be connected to the power supply of the building.

1. A fluid economizer system, comprising a fluid inlet (1) to the system, which connects to a plurality of pipes (1a, 1b and 1c) parallel arranged with respect to one another, each of which includes one or more devices for the regulation of the fluid flow (X), arranged in series with respect to one another in a single pipe, and which are selected among devices for suspension of the fluid flow and devices for the manual regulation of the fluid flow or a combination thereof in a single device; a fluid outlet of the system (2) in which said plurality of pipes (1a, 1b and 1c) converge and communicate with the fluid inlet to the construction where the system is placed (3), and an electronic control unit (5) which is connected to the devices for suspension of the fluid flow (X), said system CHARACTERIZED in that each pipe (1a, 1b and 1c) of the plurality of pipes of the system, includes an arrangement of the devices for the regulation of the fluid flow (X), selected from:
a device for the suspension of the fluid flow, followed in series by a device for the manual regulation of the fluid flow; and;
a device for the manual regulation of the fluid flow, followed in series by a device for the suspension of the fluid flow; and
a single device that includes a combination of a device for the suspension of the fluid flow and a device for the manual regulation of the fluid flow.

2. The system of claim 1, CHARACTERIZED in that further includes a barometer (4), placed next to any of the devices for the regulation of the fluid flow (X), located in any of the pipes of the plurality of pipes (1a, 1b and 1c).

3. The system of claim 1, CHARACTERIZED in that the devices for the manual regulation of the fluid flow are stopcocks (M).

4. The system of claim 1, CHARACTERIZED in that the devices for the suspension of the fluid flow are solenoid valves (S).

5. The system of claim 1, CHARACTERIZED in that the electronic control unit (5) is a Programmable Logic Controller (PLC), from which electrical conduits are derived, which contain the electrical conductors (6), (7) and (8) that electrify the solenoids (S), and are arranged in the pipes (1a), (1b) and (1c), respectively.
